(19) United States
(12) Patent Application Publication
(10) Pub. No.: US 2018/0121639 A1
(43) Pub. Date: May 3, 2018

(54) MULTI-BIOMETRIC AUTHENTICATION

(71) Applicant: Wavefront Biometric Technologies Pty Limited, Sydney (AU)

(72) Inventors: Danghui LIU, Sydney (AU); Edwin Jay SARVER, Sydney (AU)

(21) Appl. No.: 15/564,168

(22) PCT Filed: Apr. 8, 2016
(86) PCT No.: PCT/AU2016/050258

§ 371 Date: Oct. 3, 2017

(30) Foreign Application Priority Data
Apr. 8, 2015 (AU) 2015901256

(51) Int. Cl. G06F 21/32; G06K 9/00; G06K 9/64

(52) U.S. Cl. CPC G06F 21/32; G06K 9/00604; G06K 9/0061; G06K 9/2027; G06K 9/00892; G06K 9/64; G06K 9/00617

(57) ABSTRACT

A method (100) of authenticating a subject (21) using a plurality of biometric traits, comprising: determining (110) a first data set representative of a first biometric trait that is based on at least one of iris pattern or iris colour of the subject; determining (120) a second data set representative of a second biometric trait that is based on a corneal surface of the subject; comparing (130) the first data set representative of the first biometric trait with a first reference and the second data set representative of the second biometric trait with a second reference; and authenticating (140) an identity of the subject based on the comparison.

### TECHNICAL FIELD

The present disclosure relates to biometric authentication with multiple biometrics. The present disclosure may have particular application to authentication with one or more biometrics traits of the eye.

### BACKGROUND

Subjects, such as humans, have a number of biometric traits and biometric traits generally differ between subjects. Some biometric traits are more suited for authentication than other biometric traits. However to date, there is no single biometric trait and associated biometric authentication method or system, that achieves perfect reliability with zero false rejection rates and zero false acceptance rates whilst being cost effective and practical.

Biometric authentication of a subject is used in a variety of circumstances. Examples include authentication of subjects by the government at ports and airports, authentication of subjects at points of entry at secure locations, and authentication of a customer of a service provider wishing to access services (such as a bank customer and a bank).

Biometric authentication also has household applications. One example includes biometric authentication systems in door locks at a door of a house. Another example includes biometric authentication systems in mobile communication devices, tablets, laptops and other computing devices to authenticate a subject attempting to use the device.

Therefore it would be advantageous to have a biometric authentication method and system that has improved reliability and/or with lower cost. It may also be advantageous to provide a biometric authentication system and method that has a lower false reject and acceptance rates, and include features that resists spoofing.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

A method of authenticating a subject using a plurality of biometric traits, comprising: determining a first data set representative of a first biometric trait that is based on at least one of iris pattern or iris colour of the subject; determining a second data set representative of a second biometric trait that is based on a corneal surface of the subject; comparing the first data set representative of the first biometric trait with a first reference and the second data set representative of the second biometric trait with a second reference; and authenticating an identity of the subject based on the comparison.

The second biometric trait that is based on a corneal surface may include the anterior surface of the cornea and/or the posterior surface of the cornea. It is to be appreciated that in various embodiments that either one or a combination of both of the anterior and posterior surfaces of the cornea may be suitable.

In the method, the step of authenticating the identity of the subject may include applying one or more weights to the result of the comparison.

The method may further include: providing an arrangement of light, capturing a first image, wherein the first image includes a representation of an iris, and the first data set is determined from the first image; providing another arrangement of light; capturing a second image, wherein the second image includes a representation of a reflection of the arrangement of light off a corneal surface, and the second data set is determined from the second image; determining, in the second image, one or more artefacts in the representation of the reflection of the arrangement of light; and excluding the artefact from the comparison of the first data set with the first reference.

In the method, the step of excluding the artefact from the comparison may further comprise: determining an artefact mask based on the determined one or more artefacts, wherein the artefact mask masks one or more corresponding artefacts from the comparison of the first data set with the first reference.

In the method, the one or more artefacts may be a silhouette of an eyelash, wherein the eyelash is between a light path from the arrangement of light and a camera capturing the second image.

The arrangement of light may be provided by a plurality of illuminated concentric circles.

In the method, capturing the second biometric trait may be further based on the reflection of the arrangement of light off the corneal surface. The corneal surface may include an anterior corneal surface whereby the reflection includes the first Purkinje image that is reflected from the outer surface of the cornea.

In the method, capturing the second biometric trait may be further based on the reflection of the arrangement of light off a posterior corneal surface. This may include the second Purkinje image that is reflected from the inner surface of the cornea. It is to be appreciated that both the first and second Purkinje images may be used.

In the method, authenticating an identity of the subject based on the comparison may further comprise confirming that the first and second images are captured during respective one or more specified times for capturing the first and second images.

The method may further comprise: capturing one or more first images, wherein the first data set is determined from the one or more first images; capturing one, or more, second images wherein the second data set is determined from the one or more second images, and wherein authenticating the identity of the subject based on the comparison further includes confirming the first and second images were captured during respective one or more specified times for capturing the first and second images.

The one or more specified times may be based on time periods and/or sequences.

The one or more specified times may be predetermined.

Alternatively, the one or more specified times may be based, at least in part, from a result that is randomly generated.

The first image and second image may be captured in a time period of less than one second.

The first image and second image may be captured in a time period of less than 0.5 seconds.

The method may further include performing the steps of determining the first and second data sets during one or more specified times, and wherein authenticating the identity of the subject based on the comparison further includes confirming that the determined first and second data sets were determined within the respective specified times.

An image capture device may be used to capture the first and second images, and the method may further comprise determining a relative alignment of an eye of the subject and the image capture device based on the first image, first reference, second image and second reference.

In the method, the plurality of biometric traits may include a third biometric trait, and the method further includes: determining a third data set representative of a third biometric trait of the subject; and comparing the third data set representative of the third biometric trait with a third reference, and the step of authenticating the identity of the subject is further based on the comparison of the third data set and the third reference.

The third biometric trait may be based on a shape of a corneal limbus of the subject, another biometric trait of the eye, or a fingerprint of the subject.

An apparatus for authenticating a subject using a plurality of biometric traits including: an image capture device to capture one or more images; a processing device to: determine a first data set from the one or more images, the first data set representative of a first biometric trait that is based on at least one of iris pattern or iris colour of the subject; determine a second data set from the one or more images, the second data set representative of a second biometric trait that is based on a corneal surface of the subject; compare the first data set representative of the first biometric trait with a first reference and the second data set representative of the second biometric trait with a second reference; and authenticate an identity of the subject based on the comparison.

The apparatus may further comprise: a light source to provide an arrangement of light; wherein the processing device is further provided to: determine the first data set from a first image of the one or more images where the first image includes a representation of an iris; determine the second data set from a second image, wherein the second image includes a representation of a reflection of the arrangement of light off a corneal surface; determine, in the second image, one or more artefacts in the representation of the reflection of the arrangement of light; and exclude the artefact from the comparison of the first data set with the first reference.

In the apparatus, to exclude that artefact from the comparison, the processing device may be provided to: determine an artefact mask based on the determined one or more artefacts, wherein the artefact mask masks one or more corresponding artefacts from the comparison of the first data set with the first reference.

In the apparatus, to authenticate an identity of the subject based on the comparison, the processing device may be provided to: confirm that the first and second images were captured during respective one or more specified times for capturing the first and second images.

In the apparatus, the processing device is further provided to: determine the first data set from a first image of the one or more images; and determine the second data set from a second image of the one or more images, wherein to authenticate an identity of the subject based on the comparison further comprises the processing device to: confirm the first and second images were captured during respective one or more specified times for capturing the first and second images.

In the apparatus, the one or more specified times is based on time periods and/or sequences.

In the apparatus, the processing device may be further provided to determine a relative alignment of an eye of the subject and the image capture device based on the first image, first reference, second image and second reference.

An apparatus described above, wherein the apparatus performs the method of authenticating a subject described above.

A computer program comprising machine-executable instructions to cause a processing device to implement the method of authenticating a subject described above.

### BRIEF DESCRIPTION OF DRAWINGS

Embodiments of the present disclosure will be described with reference to:

FIG. 1 illustrates as schematic of an apparatus for authenticating a subject;

FIG. 2 is a side view of an eye showing light reflection from an iris for capturing a first image;

FIG. 3 is a side view of an eye showing light reflection from a corneal surface for capturing a second image;

FIG. 4 is a flow diagram of a method of authenticating a subject;

FIG. 5 is a flow diagram of part of a method of authenticating a subject further including steps to exclude an artefact from a comparison in the method;

FIG. 6 is a flow diagram of part of a method of authenticating a subject further including steps of capturing first images and capturing second images during one or more specified times;

FIG. 7 is a first image that includes a representation of an iris;

FIG. 8 is a front view of a light source showing an arrangement of light;

FIG. 9 is a second image that includes a representation of a reflection of the arrangement of light off a corneal surface;

FIG. 10a illustrates an iris band;

FIG. 10b illustrates a modified iris band;

FIG. 10c illustrates an artefact mask;

FIG. 11 is a schematic of a processing device;

FIG. 12 illustrates another first image and sample regions for determining iris colour;

FIG. 13 is a schematic of an alternative apparatus for authenticating a subject over a network;

FIG. 14(a) is a schematic cross-section view of a camera, eye and reflected light where the camera is directed at an axis substantially co-axial with the eye;

FIG. 14(b) is a representation of an image captured by the camera in FIG. 14(a);

FIG. 14(c) is a schematic cross-section view of a camera, eye and reflected light where the camera is directed off-axis with the eye;

FIG. 14(d) is a representation of an image captured by the camera in FIG. 14(c); and

FIGS. 15(a) to 15(c) are schematic representations of an eye showing the axial radius of curvature, tangential radius of curvature and corneal height.

### DESCRIPTION OF EMBODIMENTS

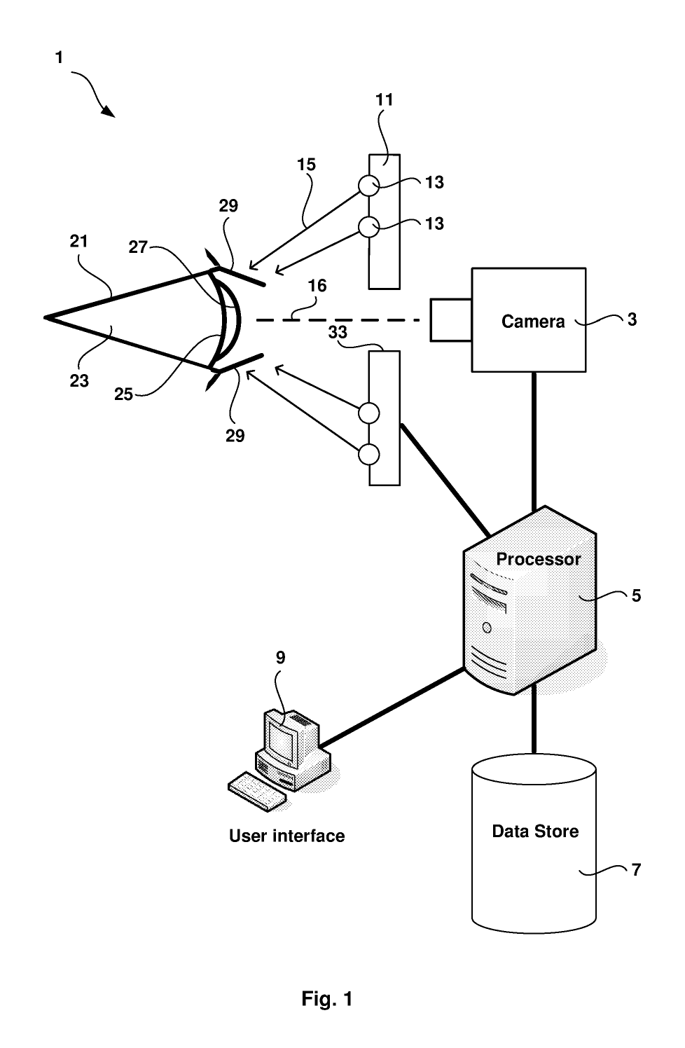

An apparatus 1 and method 100 of authenticating a subject 21 will now be described with reference to FIGS. 1 to 5.

### Overview of the Apparatus 1

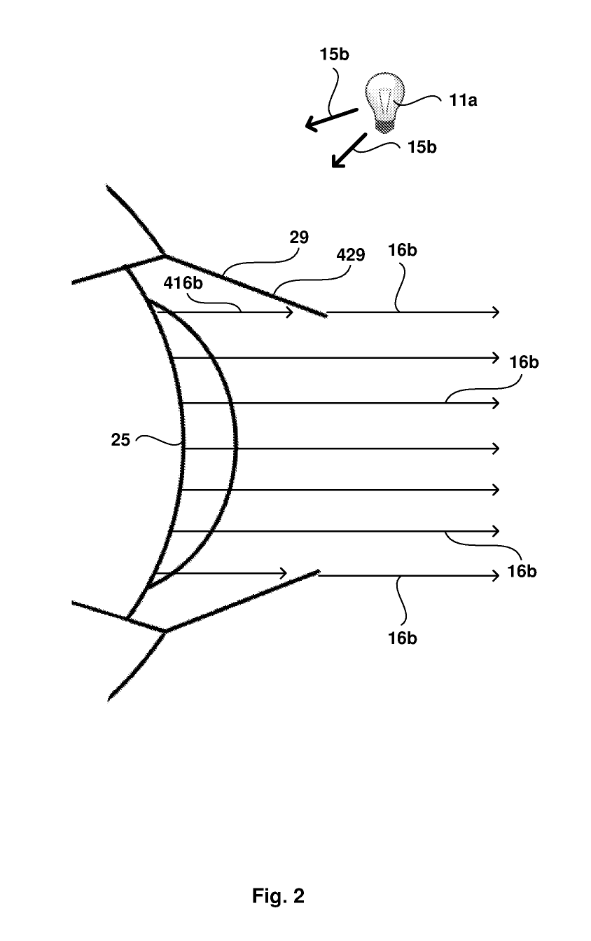

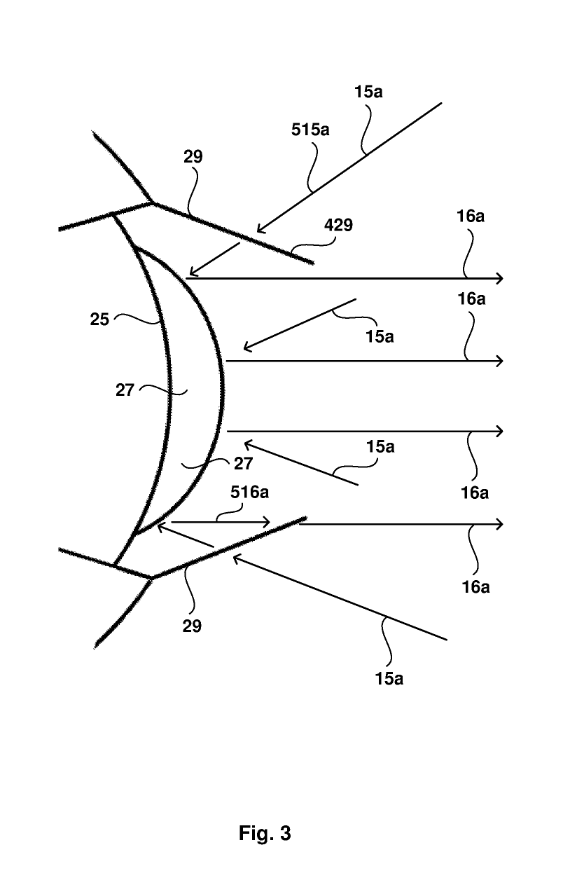

FIG. 1 illustrates an apparatus 1 including an image capture device, which may be in the form of a camera 3 and a processing device 5. The camera 3 may capture images of portions of an eye 23 of the subject 21. In particular, the camera 3 may capture images representative of the iris 25 of the subject 21 (as illustrated in FIG. 2) and representative of the cornea 27 of the subject 1 (as illustrated in FIG. 3).

The processing device 5 may be in communication with a data store 7 and a user interface 9. The apparatus 1, including the processing device 5, may perform at least part of the method 100 described herein for authenticating the subject.

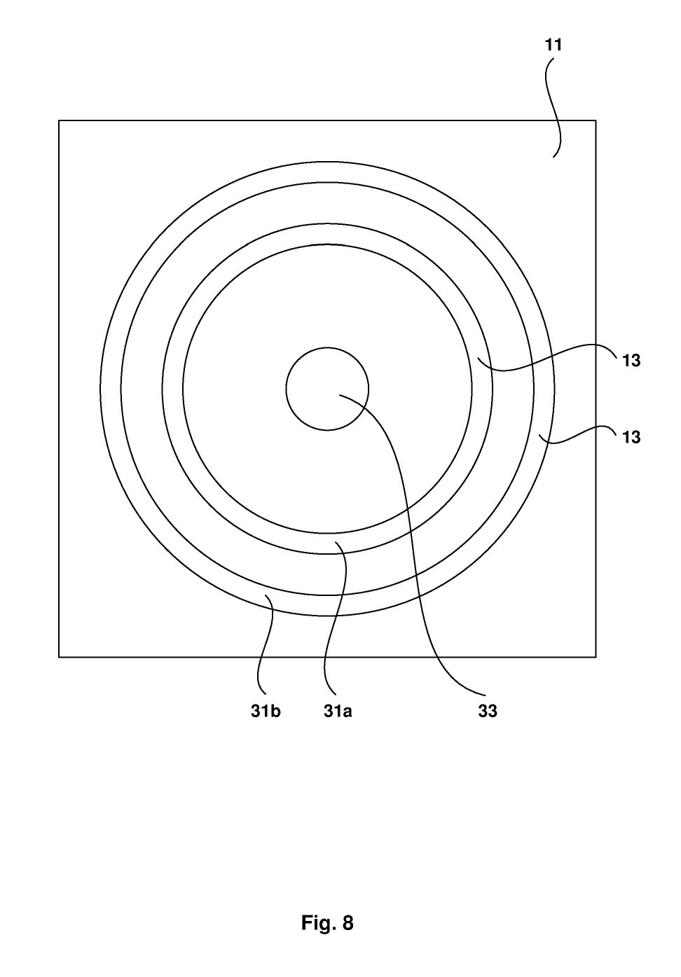

The apparatus 1 may further include a light source 11 to illuminate at least a portion of an eye 23 of the subject. The light source 11 may be configured to provide an arrangement of light 13, and in one form may be provided by a plurality of illuminated concentric circles (as shown in FIG. 8). The light source 11 provides rays of light 15 that may be reflected off the eye 23 and captured in images from the camera 3.

In one example, the apparatus 1 is part of a mobile device, a mobile communication device, a tablet, a laptop or other computing devices that requires authentication of a subject using, or attempting to use, the device. In one form, using the device may include using a particular application, accessing a particular application, accessing information or services, which may be on the device or at another device connected to the device through a communications network.

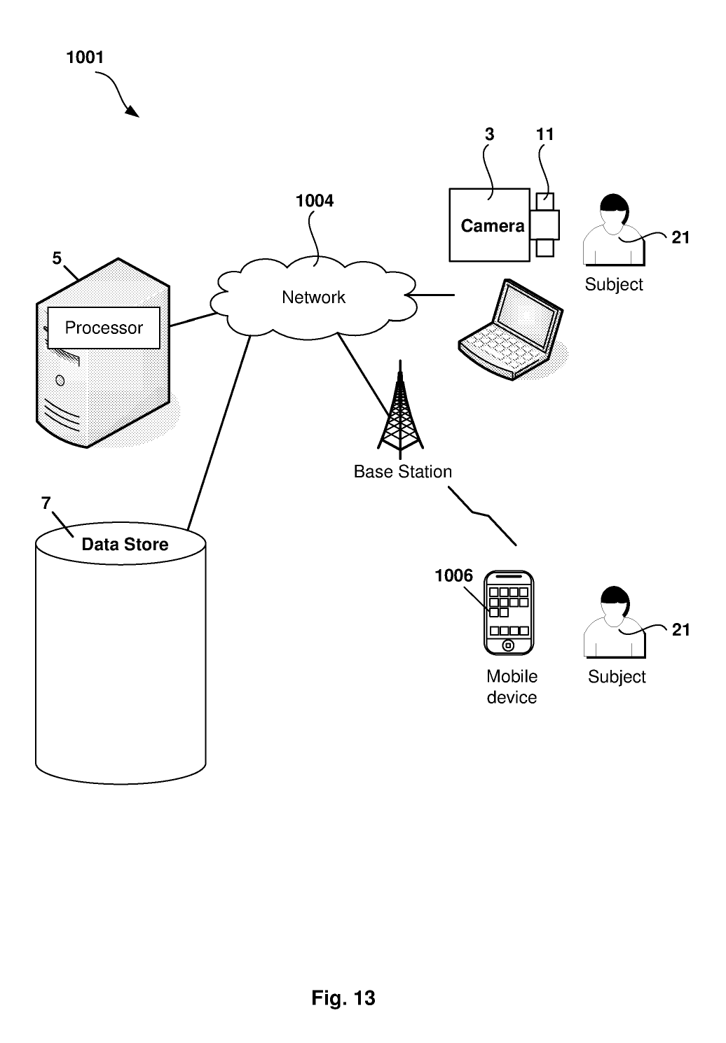

In one alternative, as illustrated in FIG. 13, the apparatus 1001 may include multiple network elements that are distributed. Components of the apparatus 1001 that are similar to the apparatus 1 described herein are labelled with the same reference numbers. The apparatus 1001 may include the camera 3 and light source 11 that is in communication, over a communications network 1004, with the processing device 5. The processing device 5 may also be in communication, over the communications network 1004, with the data store 7. Even though components of the apparatus 1001 may be located in different locations, it is to be appreciated that the method 100 described herein may also be performed by the apparatus 1001.

### Overview of the Method

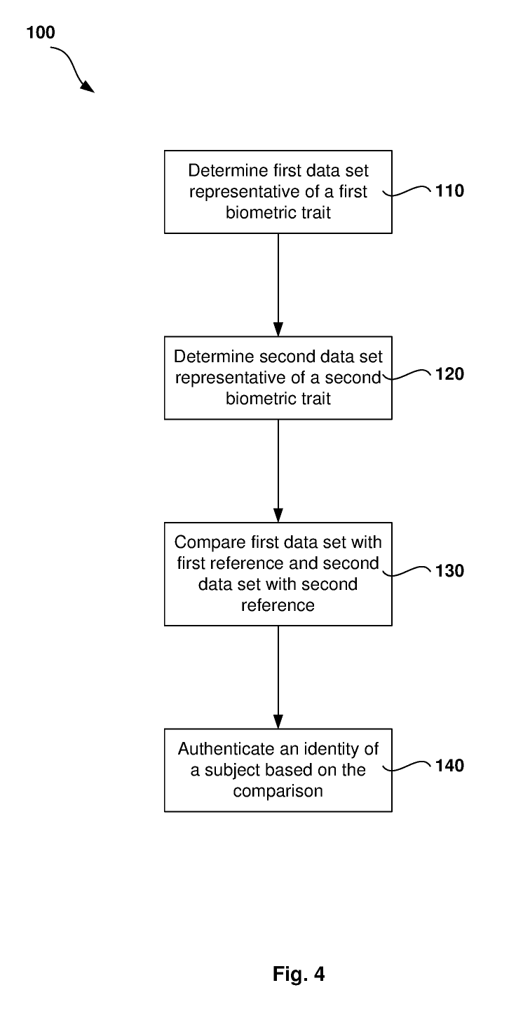

An overview of the method 100 of authenticating a subject 1 using a plurality of biometric traits will now be described with reference to FIG. 4. The method 100 includes a step of determining 110 a first data set representative of a first biometric that is based on at least one of iris pattern or iris colour of the subject. The method also includes the step 120 of determining a second data set representative of a second biometric trait that is based on a corneal surface of the subject 21. The method 100 further includes a step of comparing 130 the first data set representative of the first biometric trait with a first reference and the second data set representative of the second biometric trait with a second reference. The method 100 also includes authenticating 140 an identity of the subject 21 based on the comparison 130.

The method 100 of authenticating 140 a subject using a plurality of biometric traits may provide lower equal error rate (which is the cross over between the false acceptance rate and the false rejection rate) than authenticating using a single biometric trait.

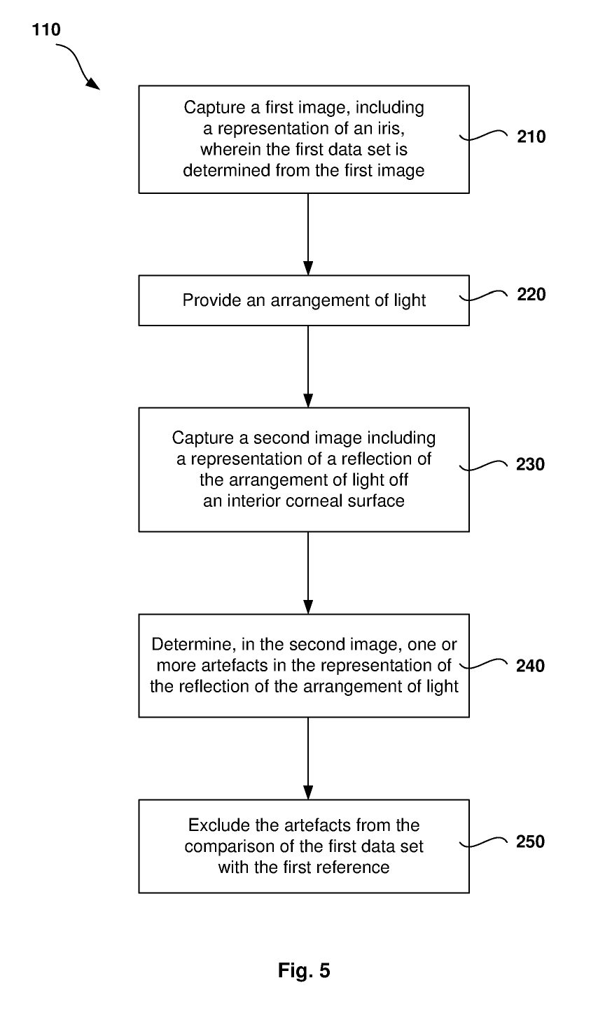

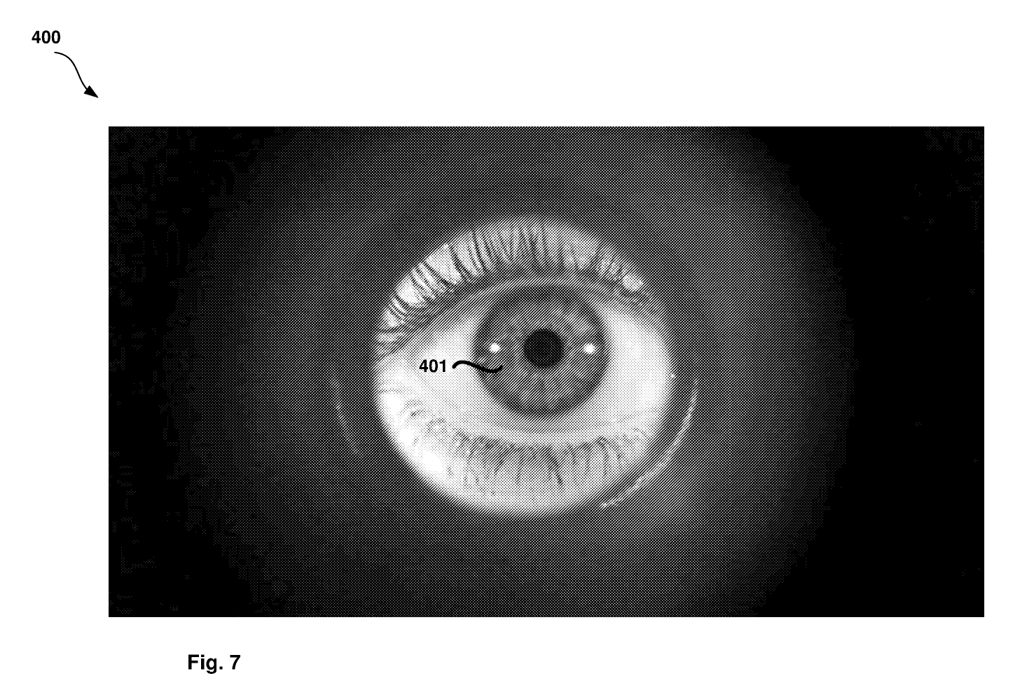

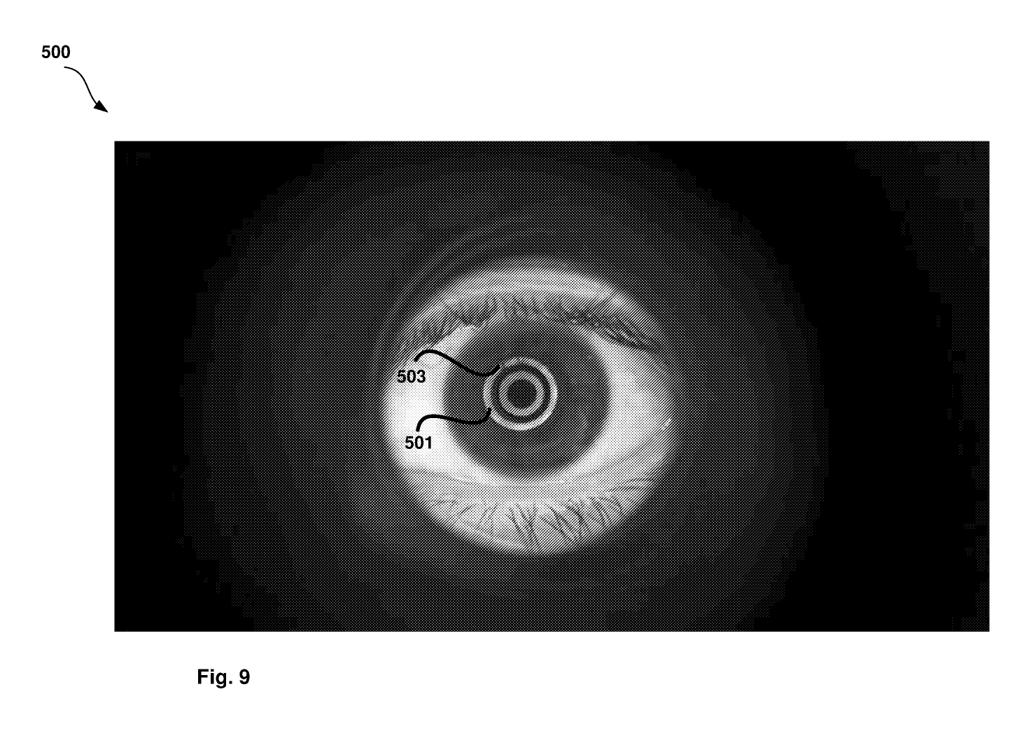

Referring to FIG. 5, the method 100 may include capturing 210 a first image 400 (as illustrated in FIG. 7), wherein the first image 400 includes a representation 401 of an iris 25, and the first data set is determined from the first image 400. The first image 400 may be captured by the camera 3. The method 100 also includes providing 220 an arrangement of light 13 (as illustrated in FIGS. 1 and 8) that may be provided by the light source 11. The method 100 subsequently includes capturing 230 a second image 500 (as illustrated in FIG. 9), wherein the second image 500 includes a representation 501 of a reflection of the arrangement of light 13 off a corneal surface of the cornea 27, and the second data set is determined from the second image 500. The next step includes determining 240, in the second image, one or more artefacts 503 in the representation of the reflection of the arrangement of light 13. The method 100 may also include excluding 250 the artefact from the comparison 130 of the first data set with the first reference.

The step of excluding 250 artefacts from the comparison may comprise determining an artefact mask based on the determined one or more artefacts. The artefact mask may be used to mask one or more corresponding artefacts from the comparison 130 of the first biometric trait with the first reference. In one example, the steps provided in FIG. 5 may be performed as part of the steps 110, 120 of determining the first and second data sets, and/or the comparison step 130. However, it is to be appreciated that one or more of these steps may be performed as part of, or as additional steps, to the method 100 shown in FIG. 4.

The artefacts may include an eyelash that is between the camera 3 and the eye 23 of the subject 21. In a particular example, the artefacts are not related to the first biometric trait (that is in turn based on an iris trait). By determining an artefact mask, a corresponding artefact that may be in the first image may be masked from the comparison 130 of the first biometric trait with the first reference. This may reduce the false rejection rates and/or false acceptance rate by excluding the artefacts from the comparison 130.

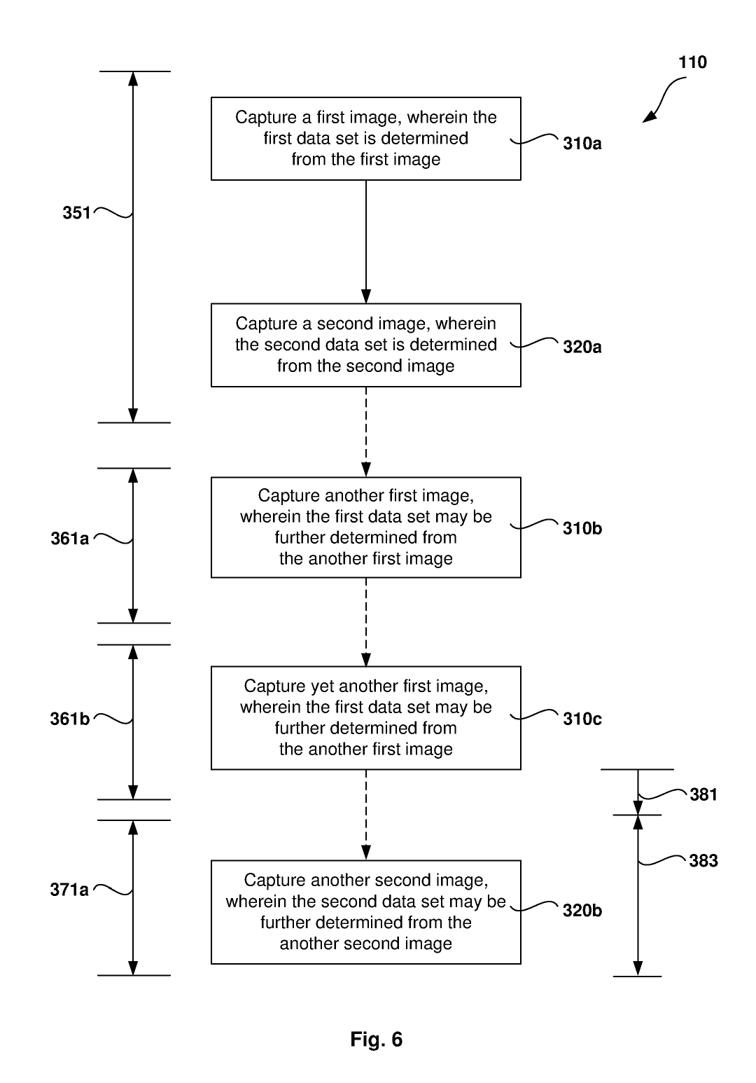

Referring to FIG. 6, the method 100 may include capturing 310 one, or more, first images, wherein the first data set is determined from the one or more first images. The method 100 may also include capturing 320 one, or more, second images wherein the second data set is determined from the one or more second images. The step of authenticating 140 the identity of the subject based on the comparison 130 may further include confirming the first and second images were captured during respective one or more specified times for capturing the first and second images.

In FIG. 6, the step 310 of capturing the first images includes capturing the first image at steps 310a, 310b and 310c. The step of capturing 320 the second images includes capturing the second image at steps 320a and 320b. Thus the specified time for capturing may include particular time periods and/or sequences in the steps of capturing the images. Furthermore, the specified time period between successive images (which may include first image to second image, first image to another first image, second image to another second image, or second image to a first image) may be specified to a short time period, for example less than one second. By specifying times for capturing the first and second images, this may reduce the opportunity that the apparatus 1 or method 100 can be successfully spoofed (i.e. deceived). In one example, the camera 3 captures both the first and second images. Therefore a person (or device) attempting to spoof the apparatus 1 or method 100 with, say a first photograph for spoofing the first image and a second photograph for spoofing the second image, will need to (i) know the respective specified periods; and (ii) be able to present respective first or second photographs to the camera 3 at the respective specified periods. By having specified periods that are unknown or difficult to obtain by the person attempting to spoof the apparatus 1 or method 1 this increases the anti-spoofing characteristics of the method. Furthermore, by having specified periods between the first and second images that are relatively short, this would also strengthen the anti-spoofing characteristics as there may be physical difficulties in quickly and accurately switching between first and second photographs for presentation to the camera at the specified times (such as specified time periods and/or sequences).

### Detailed Description of the Apparatus 1

The apparatus 1 will now be described in detail. In one embodiment the components of the apparatus 1 may be co-located, and in a further embodiment the components are in one device (for example a mobile device). However in alternative embodiments, components of the apparatus 1 may be separated and communication with one another through wired or wireless communication means. In yet further alternative embodiments, the components are geographically separated with some components located close to the subject, and other components remote from the subject to be authenticated. In such alternative embodiments such as apparatus 1001 illustrated in FIG. 13, one or more of the components may be in communication, over a communications network 1004, with another component.

### (i) Light Source 11

The light source 11 will now be described with reference to FIG. 8. In this example, the light source 11 may provide an arrangement of light 13 in the form of a plurality of illuminated concentric rings 31a, 31b. In this example, there is an inner ring 31a and an outer ring 31b.

The arrangement of light 13 may be provided by a plurality of light emitters, such as light emitting diodes (LED) that are arranged corresponding to the arrangement of light 13. Alternatively, the LEDs may be arranged closely with adjacent LEDs such that distinct LED light emitters in the arrangement of light 13 is in practice unperceivable, or barely perceivable. A light diffuser or light pipe may be used to assist in providing the arrangement of light 13. In an alternative embodiment, the LED light emitters are arranged so that light from each LED light emitter is distinguishable from an adjacent LED.

In another form, a transparent medium (that transmits at least one wavelength of light from light emitters) is configured to provide the arrangement of light 13. For example, the transparent medium may have a shape that corresponds to the arrangement of light 13, and one or more light emitters illuminate the transparent medium.

In another example, the arrangement of light may be produced by a light source (not shown) that includes a light emitter that is covered with one or more opaque surfaces. One of the opaque surfaces may have one or more annular windows to provide the arrangement of light 13.

In yet another example, the light source may be an electronic display or a light projector. In a further example, the electronic display or light projector may be reconfigurable so that the arrangement of light 13 may be selectively reconfigured both spatially and temporally.

The light arrangement 13 may have known characteristics, such as size and configuration 13, and provides incident rays of light 15a as shown in FIG. 3. In one embodiment, these incident rays of light 15a are reflected (by specular reflection) off the anterior corneal surface of the cornea 27 to provide reflected rays of light 16a. Referring to FIG. 9, the captured second image 500 has a representation 501 of a specular reflection of the light arrangement 13 off the anterior corneal surface of the cornea 27. Since the characteristics of the light arrangement 13 is known, it is possible to determine information on the anterior corneal surface of the subject, from the second image 500, which can be used as a biometric trait. For example, the anterior corneal surface of an eye 21 is not a perfect geometric shape, such as a sphere, and individual subjects compared to a population will have variances. These variances in the anterior corneal surface result in changes in the specular reflection of the light arrangement 13 that may then be used as a biometric trait for authentication.

In one example, the reflection of the arrangement of light off the anterior surface of the cornea may include the first Purkinje image. However, it is to be appreciated that capturing the second biometric trait may also be based on the reflection of the arrangement of light off a posterior corneal surface. This may include the second Purkinje image that is reflected from the inner surface of the cornea. It is to be appreciated that either one or both of the first and second Purkinje images may be used.

Although the light arrangement 13 illustrated in FIG. 8 is in the form of two concentric rings 31a, 31b, it is to be appreciated that other light arrangements 13 may be used. In one example, the light arrangement may include one, or more, illuminated strips of light. In one example, the light source 11 is a slit lamp that projects a thin sheet of light.

In other embodiments, the light arrangement 13 may be one or more of radial pattern, grid-like patterns, checkerboard pattern or spider web pattern. In yet another embodiment the light arrangement may include a combination of concentric rings with different thicknesses.

In additional embodiments, combinations of one or more of the above light arrangements may be used.

In the light source 11 illustrated in FIGS. 1 and 8, a central aperture 33 is provided to allow reflected light 16 to pass through the light source 11 and to be received at the camera 3. In one example, it is preferable to have the axis of a pupil of the eye 21, a central axis of the central aperture 33 and a camera axis of the camera 3 to be aligned along a common axis as illustrated in FIG. 1.

The light source 11 may also provide illumination to assist capturing the first image 400. The light source 11 may provide light to enable to camera 3 to capture a first image 400 that includes a representation 401 of the iris 25. In one form, the light source 11 to enable the camera 3 to capture the first image 400 may be a light source that produces diffuse light.

To capture a first image 400 to obtain a first data set representative of iris colour of the eye 21, the light source may include a flood illumination source. The flood illumination may be a white light source 11a to provide white light rays 15b in the visible spectrum. The white light from the white light source 11a (as shown in FIG. 2) is then diffusely reflected from the iris 25 of the subject. The white light source 11a may be in the form of one or more white LEDs. Due to the pigmentation of the eye 21 of the subject, only certain wavelengths will be reflected from the iris 25. The reflect light from the iris is shown as reflected rays 16b in FIG. 2. The reflected rays 16b (of the certain wavelengths that are reflected) may then be captured by the camera 3 to provide the first image.

To capture a first image 400 to obtain a first data set representative of iris pattern of the eye 21, the light source may be a white light source 11a as discussed above. In one alternative, the light source 11 may be a particular wavelength or band of wavelengths. In one form, the light source 11 for capturing a first image 500 to obtain a first data set representative of iris pattern of the eye 21 may include a near infrared light source.

### (ii) Image Capture Device—Camera 3

The image capture device 3 may be in the form of a still, or video, camera 3. The camera 3 may be a digital camera that may include one or more optical lenses and an image sensor. The image sensor is sensitive to light and may include CCD (charged coupled device) or CMOS (complementary metal-oxide-semiconductor) sensors. It is to be appreciated that other image capture device 3 technologies may be used to capture the first and second images.

In the embodiment illustrated in FIG. 1, a single camera 3 captures both the first image and the second image. Using one camera 3 to capture images for the first and second images may save materials, weight, complexity and cost of the apparatus 1. This may be important for some applications, for example where the apparatus 1 is in the form, or at least part of, a mobile device.

However, in an alternative form the apparatus 1 may include two or more image capture devices. This may be beneficial, for example, where one image capture device is suited to capture the first image, and another image capture device is suited to capture the second image.

(iii) Processing Device 5

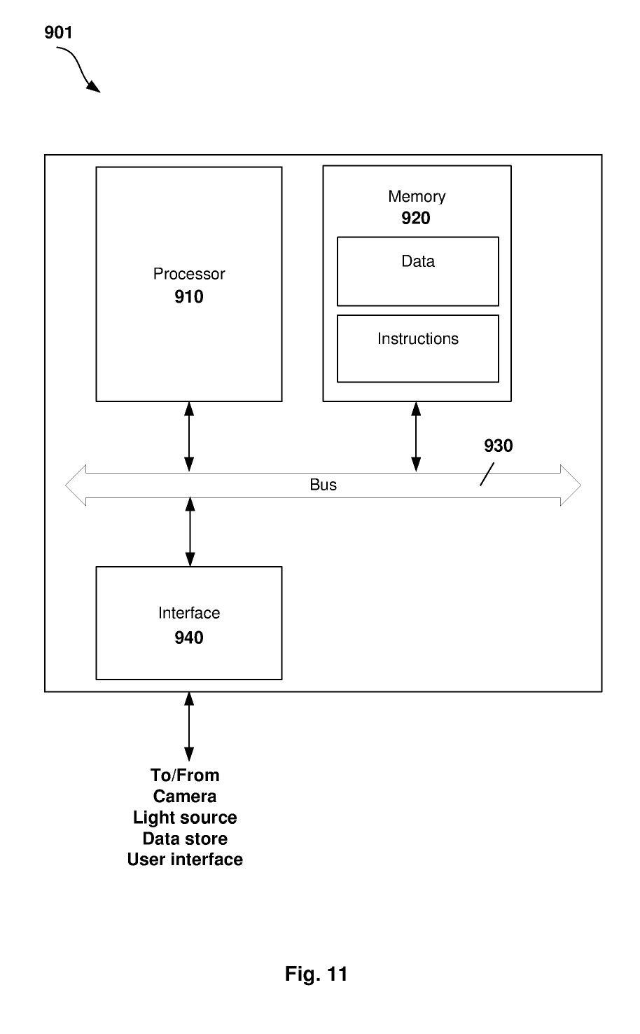

FIG. 11 illustrates an example of a processing device 901, such as the processing device 5. The processing device 901 includes a processor 910, a memory 920 and an interface device 940 that communicate with each other via a bus 930. The memory 920 stores instructions and data for implementing at least part of the method 100 described above, and the processor 910 performs the instructions from the memory 920 to implement the method 100. The interface device 940 facilitates communication with, in a non-limiting example, the camera 3, light source 11, user interface 9, and data store 7. Thus the processing device may send and receive instructions and data from these other components of the apparatus 1.

In some embodiments, the interface device 940 also facilitates communications from the processing device 901 with other network elements via the communications network 1004. It should be noted that although the processing device 901 is shown as an independent element, the processing device 101 may also be part of another network element.

Further functions performed by the processing device 901 may be distributed between multiple network elements (as illustrated in FIG. 13) that the apparatus 1, 1001 is in communication with. For example, it may be desirable that one or more of the steps of the method 100 are performed remote from the subject 21. This may be required, for example, where the apparatus 1 is part of a mobile device 1006, and it may not be desirable to have the first and second reference located in a data store 7 on the mobile device 1006 for security reasons. Therefore, the method may include firstly using a camera of the mobile device 1006 to capture the first and second images. The first and second images (and/or first and second data sets) may then be sent, over a communications network 1004, to another network element, such as processing device 5, to perform one or more of the other steps of the method 100.

### (iv) Data Store 7

The data store 7 may store the first and second reference used in the step of comparison 130. The first and second reference may be based on enrolment data during enrolment of the subject (discussed below). In one embodiment, the data store 7 is part of the apparatus 1.

In an alternative embodiment, the first and second reference may be stored in a data store that is separate from the apparatus 1. For example, the data store may be located remote from the apparatus 1, and the first and second reference is sent from the remote data store, over a communications network, to the apparatus 1 (or any other network element as required) to perform one or more steps of the method 100.

### (v) User Interface 9

The user interface 9 may include a user display to convey information and instructions such as an electronic display or computer monitor. The user interface 9 may also include a user input device to receive one or more inputs from a user, such as a keyboard, touchpad, computer mouse, electronic or electromechanical switch, etc. In one example, the user interface 9 may include a touchscreen that can both display information and receive an input.

The “user” of the user interface may be the subject wishing to be authenticated, or alternatively, an operator facilitating the authentication of the subject.

### Detailed Description of the Method of Authenticating a Subject Using a Plurality of Biometric Traits

The steps of the method 100 will now be described in detail. A step of enrolment to determine the first and second reference will first be described, followed by the steps of determining 110, 120 the first and second data set and comparing 130 the data sets with the respective references. For ease of description, the steps of determining 110, 120 and comparing 130 have been grouped and described under a separate heading for each biometric trait (i.e. iris pattern, iris colour and corneal surface). This is followed by the description of authenticating 140 the identity based on the comparisons (that involves at least two of the above mentioned biometric traits).

Excluding artefacts from the comparison will then be described, which includes determining the artefacts and determining an artefact mask. This is followed by a description of steps in the method 100 to reduce the likelihood of spoofing the method 100 (also known as “anti-spoofing”) and detection of spoofing.

In the comparison step described herein, the comparison is not limited to a match between a data set and a reference, but may also include pre and/or post processing of information that all combined may make the comparison step.

### (i) Enrolment

The first reference and second reference may be determined during enrolment of the subject, which will be performed before the method 100. Determining the first reference may include determining first reference data representative of the first biometric trait. Similarly, obtaining the second reference includes determining reference data representative of the second biometric trait.

In one embodiment, determining the first and second reference include similar steps to determining 110, 120 the first data set and second data set during authentication (which will be discussed in further detail below).

Thus determining the first reference may include capturing an image with the camera 3, wherein the image includes a representation of the iris of the subject to be enrolled, and the first reference is determined from this image. Similarly, determining the second reference may include providing the arrangement of light 13 and capturing an image, wherein the image includes a representation of a reflection of the arrangement of light off a corneal surface of the subject to be enrolled, and the second reference is determined from the image.

The enrolment process may include capturing multiple images with the camera 3 to determine multiple first and second references. The multiple determined first and second references (of the same reference type) may be quality checked with each other. If the first and second reference satisfies the quality check, one or more of the first and second references may be stored in data store 7.

Quality check is to ensure each enrolment data (the first and second references) meet certain minimum quality requirements. Such quality check may include the centre of the pupil, centre of the rings, and completeness of rings. For example, if the pupil centre is determined to be above a threshold offset from the camera centre, the reference will be rejected by the quality check. Multiple enrolment data (the first and second references) may be saved for comparison when performing the method 100 of authentication. When performing the method 100, the respective first and second data sets may compared with each of the multiple respective enrolment (first and second) references, and the highest matching score for the particular respective biometric trait may be used in the final decision making to authenticate the subject.

### (ii) Determining 110 and Comparing 130 a First Data Set Representative of a First Biometric Trait Based on Iris Pattern

Determining a first data set representative of a first biometric trait that is based on iris pattern according on one exemplary embodiment will now be described. FIG. 7 illustrates a first image 400 including a representation of the iris 25. The iris 25 of the subject includes a distinctive pattern that, in most circumstances, has a pattern from the iris of another person.

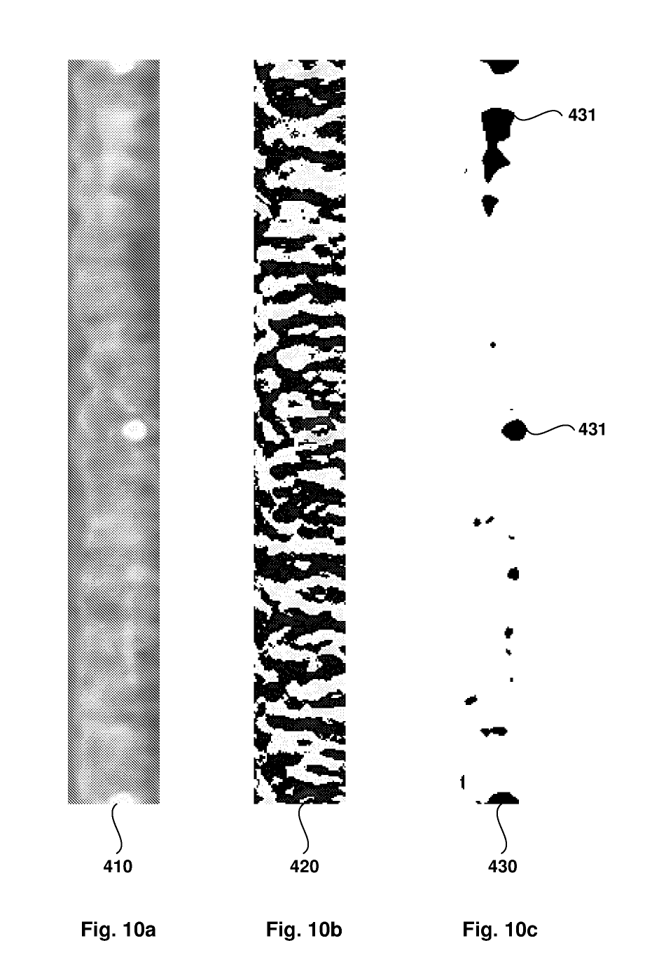

From the first image 400, the image is manipulated to provide an iris band 410 as shown in FIG. 10a. To produce an iris band 400, the centre of the pupil of the eye 23 is determined and a polar domain conversion of the first image 400 is performed, with the centre of the pupil as the origin. The polar domain conversion is only performed on the area between the pupil and the limbus margin, which contains the iris pattern, to provide the iris band 410.

The iris band 410 as shown in FIG. 10a has a representation of an iris pattern that includes blurred pattern edges. Thus the iris band 410 as shown in FIG. 10a may be difficult to utilise as a first data set. To improve matching and comparison, the edges of the iris pattern may be clarified and accentuated. In one method, this includes using an edge detection to extract the more dominant features in the iris pattern. The modified iris band 420 after edge detection is illustrated in FIG. 10b. This modified iris band 420 may have positive, zero and negative values at each pixel location. This step of using edge detection to extract the dominant features may be performed by the processing device 5.

Certain regions of the first image 400 may have artefacts 503 that need to be excluded 250 from the comparison of the first data set (representative of the iris pattern) and the first reference. The artefacts 503 may be caused by eyelashes 29 (or silhouettes of eyelashes), glare spots from light sources (such as white light source 11a), dust spots in the optical path of the camera 3, ambient light contamination, etc. This exclusion may be performed by determining an artefact mask 430 (illustrated in FIG. 10c and discussed in further detail below) and, with the artefact mask, masking the corresponding artefacts in the modified iris band 420 to provide the first data set. The result is to provide a first data set that does not include regions having the corresponding artefacts 503, so that in the comparison of the first data set with the first references the artefacts are excluded from the comparison.

In an alternative, the modified iris band 420 may be the first data set for comparison with the first reference, and wherein the artefact mask 430 is applied to mask the corresponding regions having the artefacts 503 after an initial comparison of the first data set with the first reference. This also has the effect of excluding the artefact from the subsequent result of the comparison of the first data set with the first reference.

Thus the first data set and the first reference may each be images in the form of the modified iris band 420 (or the modified iris band with an artefact mask applied), and the comparison of the first data set and the first reference may include calculating a matching score between the respective images.

In one embodiment, there may be multiple images in the first data set and the first reference, and the step of comparison may include calculating multiple matching scores between images. In further embodiments, the comparison 130 or authentication 140 may include selecting one or more of the highest matching scores. In an alternative, this may include selecting an average of two or more of the matching scores, one or more of the lowest matching scores, or a combination thereof.

(iii) Determining 110 and Comparing 130 a First Data Set Representative of a First Biometric Trait Based on Iris Colour

The first data set may be, either as an alternative, or in addition, representative of a first biometric trait that is based on an iris colour of the subject. The iris colour of the subject may include, in the present context, the colour of the iris 25 and the colour of a partial representation of the iris 25. The iris colour may be defined by one or more components of colour, including hue, value and saturation.

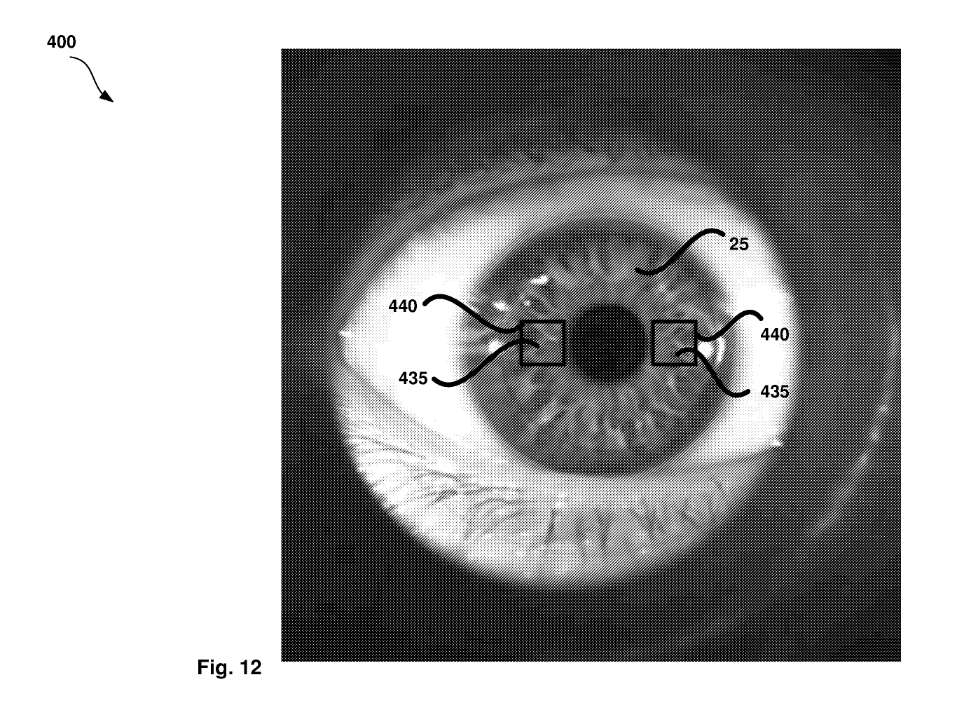

In one embodiment, with reference to FIG. 12, determining the first data set may include determining a colour (that may be expressed as a hue having a hue angle) of a region 435 of the iris 25. This may include selecting a sample region 435 of the iris 25 by selecting a pixel region of the iris 25 from a first image 400.

In one embodiment, the sample region 435 of the iris 25 may be defined as a pixel region 435, such as a 40×40 pixel box 440, to one side of the pupil 25. Additional sample regions 435 of the iris may be used, including an additional pixel region, to the opposite side of the pupil. In one example, as illustrated in FIG. 12, a pair of sample regions 435 are located to the left side and the right side of the pupil to lower the chance of the eyelids interfering with the sample regions.

The colour hue angle from the pixels in the sample region(s) 435 may then be determined to provide a first data set representative of the first biometric trait based on the iris colour. Determining the first data set may include, for example, averaging or calculating the median hue angle in the region, or determining a hue histogram.

The determined first data set (which is a colour hue angle) may then be compared with the first reference (which may also be a hue angle) such as by determining a difference between the two, or determining a matching score between the two. Similar to above, this first data set may be one of multiple first data sets that is compared with one or more first references.

In further embodiments the hue, saturation and value (HSV) or hue, saturation, lightness (HSL) coordinates may be used in the first data set and first reference.

### (iv) Determining 120 and Comparing 130 a Second Data Set Representative of a Second Biometric Trait Based on Corneal Surface

Determining a second data set representative of a second biometric trait that is based on a corneal surface according to one exemplary embodiment will now be described. As discussed above, the corneal surface of the cornea 27 of the subject will, in most circumstances, vary with other subjects in a population. Therefore the corneal surface, and in particular the shape and topology of the anterior or posterior corneal surface may be used as a biometric trait for authentication.

The corneal surface topography is directly related to the image pattern of the reflected pattern of light. The shape of the corneal surface can be represented by the shape of the reflected light pattern. In one embodiment using concentric rings, the normalized and rotation adjusted RMS of ring distance, or the normalized Fourier coefficients of the rings (which is rotation invariant) between the authentication data and reference data are used.

In one example, the reflected light pattern domain, without reconstruction of the corneal surface topography, may be used in the method 100. However, other methods may include reconstruction of the corneal surface topography, whereby the reconstruction of the corneal surface topography may be used for one or more of the first and second data sets or first and second references.

FIG. 9 illustrates a second image 500 including a representation 501 of the reflection of the arrangement of light 13 (that includes concentric rings) off an anterior corneal surface of the subject. The shape of the representation 501 may therefore be representative of biometric traits of the anterior corneal surface. It is to be appreciated that capturing the second biometric trait may also be based on the reflection of the arrangement of light off a posterior corneal surface.

In one example, determining the second data set may include determining the size and shape of one or more of the concentric rings in the representation 501 in the second image 500. The size and shape of the concentric rings may be parameterised for the second data set. Thus comparison of the second data set and the second reference may be a comparison between parameter values.

In FIG. 9, there are two concentric rings in the representation 501. The inside and outside edges of the rings may be determined, thereby providing four rings (the outside edge of the outer ring, the inside edge of the outer ring, the outside edge of the inner ring, and the inside edge of the inner ring) that may be used for the second data set. The inside and outside edges may be determined by the transition between dark to bright, or from bright to dark in the representation 501.

In one alternative, determining the second data set may include determining a reflected ring image based on the concentric rings in the representation 501 in the second image. Thus comparison of the second data set and the second reference may be a comparison between images.

Comparison between the second data set and the second reference may include determining matching scores as discussed above with respect to the comparison of the first data set and first reference. Furthermore, multiple second data sets and second references may also be compared in the same manner as the first data sets and first reference.

Although the above mentioned example is described with reference to concentric rings 31a, 31b, it is to be appreciated that other arrangement of light 13 discussed above, such as an array of discrete points, a strip of light, a radial pattern, grid-like patterns, checkerboard pattern or spider web pattern, etc. may be used.

It is to be appreciated that other forms of authentication using a biometric trait based on the corneal surface may be used. In example, known corneal topography methods may be used to determine a corneal topography of a subject. In one example, this may include a method using a Placido's disk. In another example, this may include optical coherence tomography (OCT) techniques to determine a corneal surface of the subject. The second data set may be based on the determined corneal topography.

### (v) Authenticating 140 an Identity of a Subject Based on the Comparison 130 of Multiple Biometric Traits and Respective References

In the method 100 above, authentication includes determining 110, 120 the first and second data sets, which may involve capturing 310, 320 the first and second images of the subject to be authenticated. Capturing 310, 320 the first and second images for authentication may also be known as acquisitions of the information from the (acquisition) subject to be authenticated.

After comparison 130 of the determined data sets with respective references, there is a step of authenticating 140 an identity of the subject based on the comparison. As noted above, the comparison is based on at least two biometric traits, with one based on an iris pattern or iris colour, and the other based on a corneal surface. To arrive at the decision to authenticate or not to authenticate the identity of the subject, this decision may be based on a combination of the results of the comparison with the two or more biometric traits.

In one embodiment the comparison 130 step may involve, for the comparison of a respective data set with a respective reference, providing one or more of the following:
a matching score,
one or more probability values indicative of the probability that the respective data set received in the acquisition is genuine (or imposter);
a decision on whether, based on the particular data set, that the acquired data set is that of a genuine or imposter (and consequently whether the acquisition subject is genuine or imposter compared to an enrolment subject);
a numerical score indicating the confidence of the decision of whether the acquired data set (or the acquisition subject) is genuine or imposter;
a result that indicates an indeterminate result of the comparison or an error during the comparison.
   In one embodiment, the result of the comparison of the first data set and the first reference (that is representative of the first biometric trait) may be given more weight than the result of the comparison of the second data set and the second reference (that is representative of the second biometric trait) when making the decision to authenticate the identity of the subject. Conversely, in one alternative, comparison that is representative of the second biometric trait may be given more weight than the comparison representative of the first biometric trait. In yet another embodiment comparison representative of the first and second biometric traits may be given an equal weighting. In yet another embodiment the weighting for the respective traits may be based on the trait matching score or probability values.

### (vi) Example of Authenticating 140

The step of authenticating 140 an identity of a subject in one exemplary method will now be described.

In the comparison 130, for each of the first and second data sets (representative of a respective biometric trait), respective matching scores may be determined. From these matching scores, a probability that the authentication subject is genuine (for a genuine decision class) and a probability that the authentication subject is an impostor (for an imposter decision class), representative for each of the biometric traits, is determined and provided as respective probability scores. The genuine and impostor probability may be complementary where the sum is equal to one. In some examples, the probability scores corresponding to different biometric traits are uncorrelated with each other. If they are correlated, principal components analysis (PCA) may be performed to make these scores uncorrelated. PCA analysis is known to those skilled in the art. The PCA analysis for a given biometric trait may include:
determine multiple probability scores for each biometric type in a given population for both genuine and imposter classes;
determine the normalized covariance matrix, and if the biometrics are correlated, perform PCA to make a corresponding data set uncorrelated;
determine the mean and standard deviation of each class (genuine or impostor) for each of the resulting uncorrelated data sets.

For each of the uncorrelated data sets, given the probability density function p(xᵢ|i) of each individual biometric trait and genuine and imposter class, and the assumption that a genuine or impostor acquisition subject may be present for authentication, the probability P(i|x) of genuine and impostor (the sum of both being equal to one) may be determined using equation (1):

$$P ( i \vert x ) = \frac{p ( x \vert i )}{{\sum }_{j = 0}^{1} p ( x \vert j )} \qquad Equation ( 1 )$$

where,

i=index counter for decision: 0=Genuine, 1=Impostor.

P(i|x)=Probability of decision i given the biometric trait x

j=index counter for decision class

To make a final decision to either authenticate the acquisition subject as genuine or imposter with multiple respective biometric traits, an overall score may be determined based on a combination of the probability of genuine (or imposter) probabilities for each biometric trait determined using equation 1. The overall score may be determined using equation (2):

$$P ( i \vert x ) = \frac{{\sum }_{j = 0}^{J - 1} {P}_{j} ( i \vert {x}_{j} ) {w}_{j}}{{\sum }_{j = 0}^{J - 1} {w}_{j}} \qquad Equation ( 2 )$$

where,

i=index counter for decision: 0=Genuine, 1=Impostor.

P(i|x)=Probability measure of decision i given the biometric trait x

j=index counter for the respective biometric trait

J=number of biometric traits used in authentication

wⱼ=positive weight applied to the biometric trait j to account for reliability of the respective trait.

To make the decision as to whether the acquisition subject is genuine or imposter, the overall score determined with equation (2) is used with equation (3) below. A threshold value T is provided to allow adjustments to account for false acquisition rate (FAR) and false reject rate (FRR).

$$i = \{ \begin{matrix}0 & if P ( 0 ) + T > P ( 1 ) \\ 1 & otherwise\end{matrix} \qquad Equation ( 3 )$$

where,

P(0) correspond to the composite probability of genuine as calculated from equation (2)

P(1) corresponds to the composite probability of Impostor as calculated from equation (2).

In general terms, equation 3 provides a decision that the acquisition subject is genuine (i=0) if the overall probability score of genuine plus the threshold T is greater than the overall probability score of imposter. If otherwise, then the decision is that the acquisition subject is an imposter (i=1).

In the above description, the plurality of biometric traits have been described with reference of a first and second biometric trait. However, it is to be appreciated more than two biometric traits may be used, and in a further embodiment, the plurality of biometric traits include a third biometric trait, and the method further includes: determining a third data set representative of a third biometric trait that of the subject; comparing the third data set representative of the third biometric trait with a third reference, and the step of authenticating 140 the identity of the subject is further based on the comparison of the third data set and the third reference. The third biometric trait is based on a shape of a corneal limbus of the subject, a fingerprint of a subject, etc. The shape of the corneal limbus may be determined from the first image and/or the second image.

### Determining and Excluding Artefacts

The method of determining and excluding artefacts from the comparison of the first data set with the first reference will now be described in detail.

Referring to FIG. 5, the method includes the step of capturing 210 the first image 400, including a representation of an iris, and the first data set may be determined from the first image. The processing device 5 may send instructions to the camera 3 to capture the first image 400. The camera 3, in turn, may send data corresponding to the first image 400 to the processing device 5. The processing device may send instructions to the white light source 11a, or light source 11, to provide light rays (such as white light rays 15b, or rays in one or more wavelengths) to facilitate capturing of the first image as shown in FIG. 2.

The step of providing 220 an arrangement of light 13 may be performed by illuminating the concentric rings 31a, 31b. The processing device 5 may send instructions to the light source 11 to provide arrangement of light 13. The processing device 5 may send instructions to provide 220 the arrangement of light 13 at one or more times that correspond to the step of capturing 230 a second image discussed below. However, it is to be appreciated that the light source 11 may, in some embodiments, provide the arrangement of light 13 at other times.

The step 230 of capturing the second image 500, including a representation of a reflection of the arrangement of light off a corneal surface may include the camera 3 capturing the second image 500. The processing device 5 may send instructions to the camera 3 to capture the second image while the light source 11 provides the arrangement of light 13. The camera 3, in turn, may send data corresponding to the second image 500 to the processing device 5. In this step 230, the camera 3 captures the second image 500 whilst the light arrangement 13 is provided, and in the above example the processing device 5 sends instructions separately to both the light source 11 and the camera 3. However, it is to be appreciated that other forms of coordinating the capture of the second image 500 with providing the arrangement of light 13 may be used, for example the processing device may send an instruction to the light source that in turn sends an instruction to the camera 3 to capture the second image.

The time period for the steps of capturing 210 the first image is less than one second, and in another embodiment less than 0.5 seconds. By capturing the first and second images in a short time period, the location of an artefact 503 (caused by an eyelash) in the second image may also be in the same location (or is a corresponding or offset location) in the first image. It will be appreciated that in some embodiments, that having a shorter time period between the first and second images may increase the likelihood that the location of the detected artefact in the second image may be used to determine the location of the corresponding artefact in the first image.

It is also to be appreciated that the first image 400 and second image 500 may not necessarily be captured in order. In some examples, the second image 500 may be captured before the first image 400.

### (i) Determining 240, in the Second Image, One or More Artefacts in the Representation of the Reflection of the Arrangement of Light

The step of determining 240, in the second image 500, one or more artefacts in the representation 501 of the reflection of the arrangement of light 13 in one embodiment will now be described. Referring to FIG. 9, the light arrangement 13 provides a specular reflection 501 (of concentric rings) off the corneal surface that is significantly brighter than the diffuse reflection of light off the iris 25. In FIG. 9, the representation of the reflection 501 is, in general, substantially white (or lighter) compared to the light reflecting off the iris 25. Exceptions to this are the artefacts 503 that are shown as dark lines or stripes. In FIG. 9, the artefacts 503 are silhouettes (or shadows) of eyelashes 29 that are in the path of incident light rays 15a (such as 515a in FIG. 3). Such artefacts 503 may also be caused by eyelashes in the path of reflected light rays 16a (such as 516a in FIG. 3).

Therefore the artefacts 503 in the representation 501 may be determined by detecting relatively darker pixels in the relatively brighter representation 501 of the arrangement of light.

(ii) Excluding 250 the Artefact from the Comparison of the First Data Set with the First Reference and Determining an Artefact Mask

Excluding 250 the artefact from comparison of the first data set with the first reference, such as using an artefact mask 430, was described above. The step of determining the artefact mask 430 based on the determined artefacts 503 will now be described.

After the step 240 of determining the artefacts 503 in the representation 501 (as shown in FIG. 9, the corresponding location of these artefacts 503 that may appear in the first image (or images derived from the first image such as the iris band 410 or modified iris band 420), or the first data set, is determined. The corresponding location will be better understood with reference to the relationship between a common artefact that affects both the first and second images.

Referring to FIGS. 2 and 3, the relationship between a particular artefact, such as that caused by eyelash 429, in both the first and second images will now be described. Referring first to FIG. 3, eyelash 429 is in the path of incident ray 515a, which when the reflected ray 16a is captured by the camera in the second image 500, causes an artefact in the second image. Referring to FIG. 2, it may be expected that the same eyelash 429 would also be in a path of light that may cause an artefact in the first image. In particular, after the incident light 15b diffusely reflects off the iris, the same eyelash 429 may be in the path of a reflected ray of light 416b. The reflected ray of light 416b is then captured in a first image 400 by the camera 3 and a corresponding artefact may be expected in the first image 400.

The corresponding artefact in the first image 400 may not be located in the exact location as the artefact 503 in the representation 501 in the second image. For example, it may be determined that the corresponding artefact would be in an offset location in the first image 400, due to different locations of the light source 11 and white light source 11a, that may cause the silhouette (or shadow) of the eyelash 29 to be located in a corresponding offset location.

In some embodiments, additional artefacts in the first image 400 may be known or determined from the first image 400. For example, the white light source 11a may produce a specular reflection off the anterior corneal surface such as a glare spot. The location (or the approximate location) of the glare spot produced in the first image 400 may be known or approximated for a given configuration of the apparatus 1. Therefore it may be possible to additionally determine artefacts in the first image 400. In one embodiment the location of these artefacts may be determined or approximated from the locations of such artefacts in previously captured first images.

The corresponding artefacts (and locations), such as those determined from the second (and, in some embodiments, the first image), may be used to determine an artefact mask 430 as illustrated in FIG. 10c. The artefact mask 430 includes mask portions 431 at locations where the expected corresponding artefacts may be located. The determined artefact mask 430, in FIG. 10c, is in the form of a band suitable for masking the iris band 410, or modified iris band 420. However, it is to be appreciated that the mask 430 may be in other forms.

It is to be appreciated that the mask portions 431 may be in portions larger than the expected corresponding artefact in the first image. This may provide some leeway to account for variances in the actual location of the artefact in the first image compared to the determined location of the artefact (that was based on the artefact in the second image).

### Reducing Likelihood of Successful Spoofing, and Detection of Spoofing, of the Apparatus and Method

The method may also include steps to reduce the likelihood of successful spoofing, and detection of spoofing, of the apparatus 1 and method 100 which will be described with reference to FIG. 6.

The method includes capturing 310 the first image 400 and capturing 320 the second image 500. These images may be captured multiple times, and for ease of reference successive steps of capturing have been identified with the suffix “a”, “b” and “c” in FIG. 6.

The step of capturing 310 the first image 400 may be the same, or similar, to capturing 210 the first image described above with reference to FIG. 5. Similarly, the step of capturing 320 the second image 500 may also be the same, or similar, to capturing the second image 230 described above with reference to FIG. 5.

To reduce the likelihood of spoofing, the step of capturing 310 the first image and capturing 320 the second image may have one or more specified times for capturing the images. As noted above, specifying the times for capturing the first and second images may reduce the likelihood or the opportunity that the apparatus 1 or method 100 can be successfully spoofed. In particular, the person (or device) attempting to spoof will need to know the specified periods for capturing the first and second images. Furthermore, the person (or device) will need to be able to present, during those specified times, the respective spoofing photographs (or other spoofing material) to the camera 3 during those specified times.

When authenticating 140 the identity of the subject 21 (or in preceding steps), the method 100 may further include confirming that the first and second images were captured during respective one, or more, specified times for capturing the first and second images. If one or more of the first and second images were captured outside the specified times, then the method may include not authenticating the acquisition subject as genuine (e.g. determining the acquisition subject as an imposter).

The specified times may include, but are not limited to, specified times randomly generated (from instructions in software in combination with a processing device) for one or more of the first and second images to be captured by the camera. It will be appreciated that the specified times for capturing the first and second images may be in a variety of forms as discussed below.

In one embodiment, the specified time may include a time period 351 to: capture 310a the first image; and capture 320a the second image, as illustrated in FIG. 6. The time period 351 (which may also be described as a “time window”) may have a defined value, such as one second. In another embodiment, the time period 351 may be less than one second. In further embodiments, the time period 351 may be 0.5 seconds, 0.2 seconds, 0.1 seconds, or less. It is to be appreciated that a relatively short time period 351 may strengthen the anti-spoofing characteristics as there may be physical difficulties for a person (or device) to spoof the capturing of the first and second images in quick succession.

In another embodiment, the specified time may include specifying one, or more, particular time period 361, 371 for capturing respective first and second images. For example, the specified time may include specifying first images to be captured during first image time periods 361a, 361b. Similarly, the specified time may include specifying second images to be captured during second image time period 371a. In one embodiment, it is preferable that the first image time period(s) 361 do not overlap, in time, with the second image time period(s) 371. In some examples, the length of the first and second time periods 361, 371 may be one second, 0.5 seconds, 0.2 seconds, 0.1 seconds, or less.

In addition to specifying the length of the first and second time periods 361, 371, the timing of the specified first and second time periods 361, 371 may be specified. In one example, the specifying the timing of the first and second time periods 361, 371 may be relative to a particular point in time. For example, it may be specified that time period 361a commences at one second after the method 100 commences, time period 361b commences two second after the method 100 commences, and time period 371a commences three seconds after the method 100 commences. In other examples, the timing may be based on a time of a clock.

In another embodiment, the specified time may include specifying one or more sequences for capturing the respective first and second images. For example, the method may include specifying that first and second images are captured in alternating order. This may include capturing in order, a first image, a second image, another first image, another second image. It is to be appreciated that other sequences may be specified, and sequences that are less predictable may be advantageous. For example, FIG. 6 illustrates a sequence that includes capturing: a first image 310a, a second image 320a, a first image 310b, a first image 310c, and a second image 320b.

In yet another embodiment, the specified time may include specifying that one or more images should be captured in a time period 383 that is offset 381 relative to another captured image. For example, the method may include capturing 310c a first image and specifying that capturing 320b the second image must be captured during a time period 383 that is offset 381 from the time the first image was captured 310c. In another example, a specified time period for 383 for capturing a second image may begin immediately after a first image is captured (i.e. where the offset 381 is zero). Thus in this embodiment the specified times, or at least part thereof, may be determined by an event that is not predetermined.

In some embodiments, where suitable, the specified times may be predetermined before capturing 310, 320 the first and second images. For example, one or more sequences may be determined and stored in the data store 7, and when performing the method 100 the processing device 5 may receive the sequence and send instructions to the camera 3 to capture 310, 320 the first and second images in accordance with the sequence. Similarly, the processing device may send instructions to the camera 3 to capture 310, 320 the first and second images in accordance with other predetermined specified times, such as time period 351, 361, 371.

In some embodiments, one or more of the specified times are based, at least in part, on a result that is randomly generated. In one example, the specified time includes a sequence, and the sequence is based on a result that is randomly generated. This may make the specified time less predictable to a person (or device) attempting to spoof the apparatus 1. In another example, the specified times include specifying time periods 361 and 371 to occur relative to a particular point in time, and the result that is randomly generated determines the time periods 361 and 371 relative to the particular point in time.

It is to be appreciated that combinations of two or more of the specified times, including those discussed herein, may also be used. For example, the method may include specifying a sequence for capturing 310, 320 the first and second images (such as the order provided in FIG. 6) as well as specifying a time period in which all the captured 310a, 320a, 310 a, 310c, 320b first and second images must be captured within an overall specified time period.

In the above embodiments, the method includes confirming that the first and second images were captured during respective specified times. However, it is to be appreciated that respective times that the first and second data sets are determined may be dependent, at least in part, on the time that the respective first and second images are captured. Therefore it is to be appreciated that in some variations, the method may include confirming that the first and second data sets were determined within respective specified times. Such variations may include corresponding features discussed above for the method that includes confirming specified times for capturing the images.

Since the eye is living tissue, some changes to the physical characteristics may be expected over time. Furthermore, it may be unlikely that the camera 3 could take an identical first image every time. Therefore, when capturing multiple first images, there will be some variances in the first images (and the corresponding first data sets). The method may further include comparing a first data set with a previously determined first data set. If the result of this comparison indicates that the first data set is identical to the previously determined data set, this may be indicative of an attempt to spoof the apparatus 1 (such as using a photograph or previously captured image of the eye). A similar method may also be used in relation to the second data set. Similarly, it may be expected that there will be variances between the data sets and the respective references, and if the data sets are identical to the respective references this may be indicative of an attempt to spoof the apparatus 1 and that the acquisition subject should not be authenticated.

### Using Parallax to Determine Alignment of the Camera

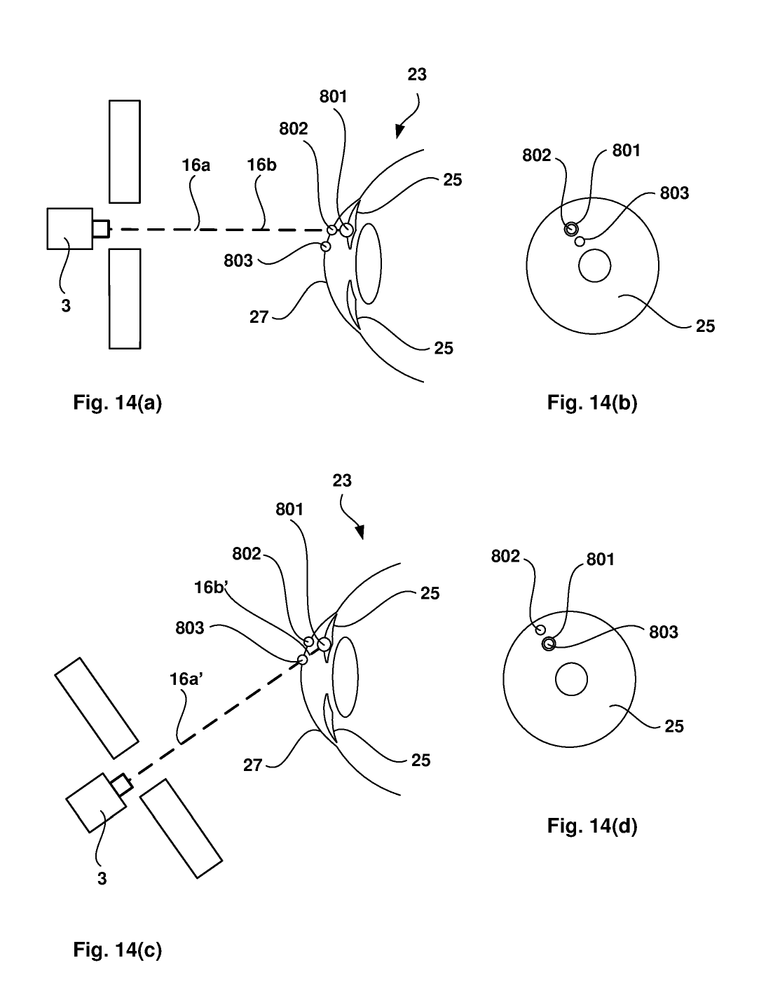

The close and fixed relative positioning of the cornea 27 and the iris 25 may allow an opportunity to determine the relative alignment between the camera 3, light source 11 and the eye 23. In particular, parallax differences determined by comparing captured first and second images with respective first and second references may be used to determine alignment. This will be described with reference to FIGS. 14(a) to 14(d).

Referring to FIGS. 14(a) and 14(b), this is a situation where the camera 3 is facing a direction parallel to axis of the eye 23. FIG. 14(a) shows a schematic cross-section of the camera 3, eye 23 and reflected light 16, whilst FIG. 14(b) shows a representation of the image captured by the camera 3. The cornea 27 is posterior to the iris 25 such that a reflected light ray 16b from a first point 801 of the iris 25 will have a path that is coaxial with the reflected light 16a that is reflected from a second point 802 of the cornea 27. This is best illustrated in FIG. 14(b) where the first point 801 and second point 802 are co-located when viewed from the perspective of the camera 3. It is to be appreciated that the first point 801 and second point 802 may be visible by the camera during capture of respective first and second images, or, in some circumstances, be visible in a single image as shown in FIG. 14(b).

FIGS. 14(a) and 14(b) also show a third point 803 on the cornea 802, separate to first point 801, which will be described in further detail below.

Referring now to FIGS. 14(c) and 14(d), these show a situation where the camera 3 is directed off-axis to the eye 23. This results in a parallax differences such that the reflected light 16b′ from the first point 801 of the iris 25 will have a path that is coaxial with the reflected light 16a′ that is reflected from a third point 803 of the cornea 27.

The relative spatial location of the first, second and third points 801, 802, 803 (or any other points and features of the iris 25 and cornea 27 that reflect rays 16) can be used to determine the relative alignment of the camera 3 to the eye 23. Information regarding the spatial locations of these points 801, 802, 803 may be included in the first and second references.

Determination of the alignment may be useful in a number of ways. Firstly, determination of alignment (or misalignment) may be used to determine adjustment and/or compensation between the reference and the captures image(s). This may improve the reliability of the method and apparatus 1 as slight changes in gaze of the subject can be taken into account when authenticating the subject. Furthermore, in practical applications it may be expected that there will be some variances between the relative direction of the eye and the camera. Determination that there acquired images include such variances may be indicative that the subject is alive. This may be in contrast to receiving first and second images that are identical to previously captured images which may be indicative of an attempt to spoof the apparatus 1.

Furthermore, determination of alignment may be useful for determining parts of the images that include artefacts. For example, in some environments there may be specular reflections from external light sources (such as a light in the room, the sun, a monitor, etc) that cause artefacts (such as glare spots described above) that may interfere with, or be confused with, the light from light source 11. By determining a relative alignment between the camera 3 (and apparatus 1) with the eye 23, this may allow determination on whether such reflections are artefacts or are from specular reflection of the light source 11. For example, determining the alignment may allow the apparatus 1 to determine regions in the second image to have the corresponding reflected light from the arrangement of light of the light source 11. This may assist masking of light that is not in the expected regions. Furthermore, this may assist in determining that certain areas of the first and or second images may be affected by artefacts and that authentication should be performed by comparing data sets corresponding to unaffected regions. This may allow an advantage that authentication can be performed in more diverse lighting conditions.

### Types of Corneal Traits

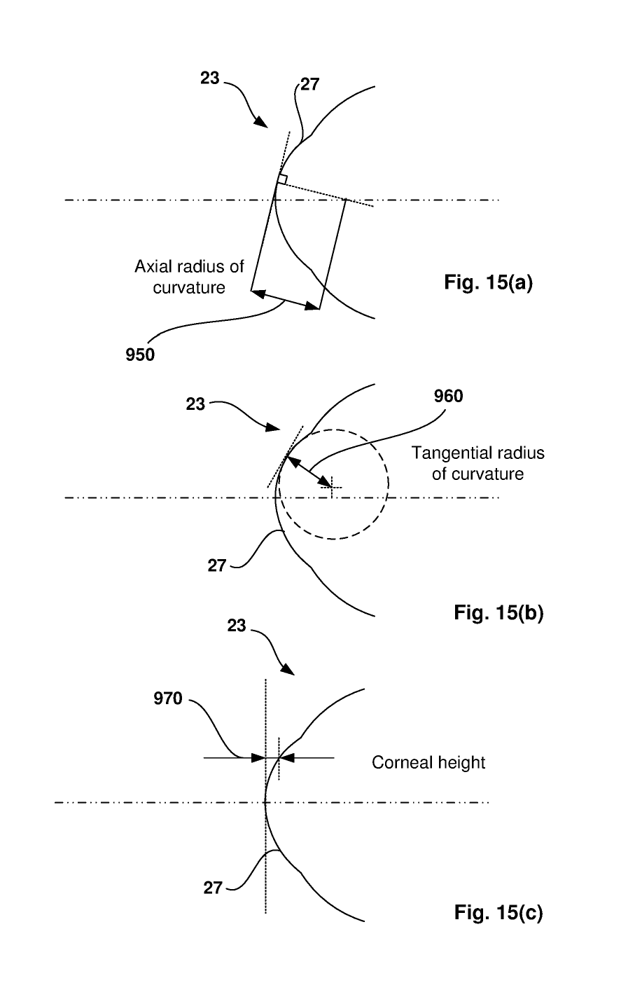

It is to be appreciated that one or more corneal traits may be used for the second biometric trait in the method. It is to be appreciated that multiple biometric trait may be used in the method of authenticating, wherein the multiple biometric traits may be used with respective weights. In some examples, the axial radius 950 (as shown in FIG. 15(a)) and/or the corresponding axial power may be used with a relative higher weight. In further examples, the tangential radius 960 (as shown in FIG. 15(b)) and/or the corresponding tangential power may be used. In some examples the corneal height 970 (as shown in FIG. 15(c)) may also be used. In yet further examples corneal astigmatism may be used.

Types of corneal biometric traits that could be used for the second biometric trait may include one or more of those listed in Table 1.

TABLE 1

| | Corneal Biometric |
|---|---|
| 1 | Wavefront Error_Zernike Fit |
| 2 | Wavefront error |
| 3 | axial radius |
| 4 | axial power |
| 5 | tangential radius |
| 6 | tangential power |
| 7 | corneal height |
| 8 | corneal diameter |
| 9 | corneal elevation |
| 10 | corneal astigmatism (SteepK-Flat K) |
| 11 | flat K angle |
| 12 | flat eccentricity |
| 13 | flat K angle |
| 14 | H(0, 0): Piston |
| 15 | H(0, 4) Spherical aberration |
| 16 | H(1, 1): Tilt |
| 17 | H(−1, 1): Tilt |
| 18 | H(1, 3): Coma |
| 19 | H(−1, 3): Coma |
| 20 | H(2, 2): Astigmatism |
| 21 | H(−2, 2): Astigmatism |
| 22 | H(2, 4): 2ndary Astigmatism |
| 23 | H(−2, 4): 2ndary Astigmatism |
| 24 | H(3, 3): Trifoil |
| 25 | H(−3, 3): Trifoil |
| 26 | H(4, 4): Tetrafoil |
| 27 | H(−4, 4): Tetrafoil |
| 28 | horizontal e |
| 29 | horizontal p |
| 30 | horizontal Q |
| 31 | HVID |
| 32 | iris area |
| 33 | iris circumference |
| 34 | Infeior/Superior Corneal Power Index |
| 35 | steep e |
| 36 | steep K |
| 37 | steep p |
| 38 | steep q |
| 39 | vertical e |
| 40 | vertical p |
| 41 | vertical q |
| 42 | w (1, 3): Coma |
| 43 | w (−1, 3): Coma |
| 44 | w (2, 2): Astigmatism |
| 45 | w(−2, 2): astigmatism |
| 46 | w (2, 2): Secondary Astigmatism |
| 47 | w (−2, 2): Secondary Astigmatism |
| 48 | W (3, 3): Trifoil |
| 49 | W (-3, 3): Trifoil |
| 50 | w (4, 4): Tetrafoil |
| 51 | w (−4, 4): Tetrafoil |

It will be appreciated that the apparatus 1 and method 100 may be used to authenticate a subject that is a human. Furthermore, the apparatus 1 and method may be used to authenticate an animal (such as a dog, cat, horse, pig, cattle, etc.).

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method of authenticating a subject using a plurality of biometric traits, comprising:
determining a first data set representative of a first biometric trait that is based on at least one of iris pattern or iris colour of the subject;
determining a second data set representative of a second biometric trait that is based on a corneal surface of the subject;
comparing the first data set representative of the first biometric trait with a first reference and the second data set representative of the second biometric trait with a second reference; and
authenticating an identity of the subject based on the comparison.

2. The method according to claim 1 wherein the step of authenticating the identity of the subject includes applying one or more weights to the result of the comparison.

3. The method of claim 1 further comprising:
capturing a first image, wherein the first image includes a representation of an iris, and the first data set is determined from the first image;
providing an arrangement of light;
capturing a second image, wherein the second image includes a representation of a reflection of the arrangement of light off a corneal surface, and the second data set is determined from the second image;
determining, in the second image, one or more artefacts in the representation of the reflection of the arrangement of light; and
excluding the artefact from the comparison of the first data set with the first reference.

4. The method according to claim 3 wherein the step of excluding the artefact from the comparison comprises:
determining an artefact mask based on the determined one or more artefacts,
wherein the artefact mask masks one or more corresponding artefacts from the comparison of the first data set with the first reference.

5. The method of claim 3 wherein the first image and second image are captured in a time period of less than one second.

6. (canceled)

7. The method according to claim 3 wherein the one or more artefacts is a silhouette of an eyelash, wherein the eyelash is between a light path from the arrangement of light and a camera capturing the second image.

8. (canceled)

9. The method according to claim 3 wherein capturing the second biometric trait is further based on the reflection of the arrangement of light off the corneal surface.

10. (canceled)

11. The method according to claim 3 wherein authenticating an identity of the subject based on the comparison further comprises confirming the first and second images are captured during respective one or more specified times for capturing the first and second images.

12. The method according to claim 1 comprising:
capturing one or more first images, wherein the first data set is determined from the one or more first images; and
capturing one, or more, second images wherein the second data set is determined from the one or more second images,
wherein authenticating the identity of the subject based on the comparison further includes confirming the first and second images were captured during respective one or more specified times for capturing the first and second images.

13.-17. (canceled)

18. The method according to claim 1 wherein the method includes performing the steps of determining the first and second data sets during one or more specified times, and wherein authenticating the identity of the subject based on the comparison further includes confirming the determined first and second data sets were determined within the respective specified times.

19. The method according to claim 3, wherein an image capture device is used to capture the first and second images, the method further comprising:
determining a relative alignment of an eye of the subject and the image capture device based on the first image, first reference, second image and second reference.

20. A method according to claim 1 wherein the plurality of biometric traits includes a third biometric trait, and the method further comprises:
determining a third data set representative of a third biometric trait of the subject; and
comparing the third data set representative of the third biometric trait with a third reference,
and the step of authenticating the identity of the subject is further based on the comparison of the third data set and the third reference, wherein the third biometric trait is based on a shape of a corneal limbus of the subject.

21. (canceled)

22. An apparatus for authenticating a subject using a plurality of biometric traits comprising:
an image capture device to capture one or more images;
a processing device to:
determine a first data set from the one or more images, the first data set representative of a first biometric trait that is based on at least one of iris pattern or iris colour of the subject;
determine a second data set from the one or more image, the second data set representative of a second biometric trait that is based on a corneal surface of the subject;
compare the first data set representative of the first biometric trait with a first reference and the second data set representative of the second biometric trait with a second reference; and
authenticate an identity of the subject based on the comparison.

23. The apparatus according to claim 22 further comprising:
a light source to provide an arrangement of light;
wherein the processing device is further provided to:
determine the first data set from a first image of the one or more images where the first image includes a representation of an iris;
determine the second data set from a second image, wherein the second image includes a representation of a reflection of the arrangement of light off a corneal surface;
determine, in the second image, one or more artefacts in the representation of the reflection of the arrangement of light; and
exclude the artefact from the comparison of the first data set with the first reference.

24. The apparatus according to claim 23 wherein the processing device excludes from the comparison by:
determining an artefact mask based on the determined one or more artefacts,
wherein the artefact mask masks one or more corresponding artefacts from the comparison of the first data set with the first reference.

25. The apparatus according to claim 23 wherein to authenticate an identity of the subject based on the comparison further comprises the processing device to:
confirm the first and second images were captured during respective one or more specified times for capturing the first and second images.

26. The apparatus according to claim 22 wherein the processing device is further provided to:
determine the first data set from a first image of the one or more images; and
determine the second data set from a second image of the one or more images,
wherein to authenticate an identity of the subject based on the comparison further comprises the processing device to:
confirm the first and second images were captured during respective one or more specified times for capturing the first and second images.

27. The apparatus according to claim 26 wherein the one or more specified times is based on time periods and/or sequences.

28. The apparatus according to claim 22, wherein the processing device is further provided to:
determine a relative alignment of an eye of the subject and the image capture device based on the first image, first reference, second image and second reference.

29. (canceled)

30. A non-transitioning computer recordable medium containing machine-executable instructions to cause a processing device to perform the method of claim 1.
